(19) United States
(12) Patent Application Publication
(10) Pub. No.: US 2002/0138655 A1
(43) Pub. Date: Sep. 26, 2002

(54) Reducing memory copies by a network controller

(76) Inventors: Lucas M. Jenison, Hillsboro, OR (US); Linden Minnick, Hillsboro, OR (US)

Correspondence Address: FISH & RICHARDSON, PC, 4350 LA JOLLA VILLAGE DRIVE, SUITE 500, SAN DIEGO, CA, 92122, US

(21) Appl. No.: 09/814,362

(22) Filed: Mar. 21, 2001

(51) Int. Cl. G06F 15/16; G06F 3/00

(52) U.S. Cl. 709/250; 710/52

(57) ABSTRACT

The number of memory copies in a network may be reduced by monitoring the state of the controller resources. If the controller resources run low while processing an array of data packets, the current data packet is marked and all subsequent data packets are flagged. When the array is fully processed, the controller resources are checked again. If the resources are still low, the flagged data packets are copied to buffers. However, if the controller resources are no longer low, the network controller removes all the flags and the data packets may be copied directly into the host memory at a later time.

### TECHNICAL FIELD

This invention relates to computer networks, and more particularly to controlling the transfer of packets from a network controller to a buffer.

### BACKGROUND

A computer network is a system of hardware and software that allows two or more computers to communicate with each other. Networks are of several different kinds. For example, local area networks (“LAN”) connect computers within a work-group or department. There are campus networks which extend to multiple buildings on a campus. There are metropolitan area networks, (“MAN”) which span a city or metropolitan area. There are wide area networks (“WAN”) that make connection between nodes in different cities, different state and different countries.

In a communications network, a network controller manages transmission and reception of data packets by transferring data between the network and a shared memory subsystem. The shared memory is used by several different devices including the system CPU, I/O devices and disks as well as the network controller. The network adapter accesses the shared memory by a shared system bus. The network controller uses packet descriptors or an analogous data structure to describe the specific information about each data packet, e.g. type, length and size. The packet descriptors are typically located in the shared memory subsystem along with the data packets. To transmit or receive a data packet, the network controller should access the packet descriptor of the particular data packet, transfer the data for the packet from or to the shared memory, and then update the packet descriptor with the new status.

Due to the nature of computer networks, all packets should be delivered to the network operating system in the order they were received. On high-speed networks, several packets may be received before a software driver is called to process the packets. In these circumstances, the packets reside in the shared memory until the operating system copies the packets to the host memory. However, if the controller is running low on resources while processing an array of packets, it may free up resources by copying packets into operating system buffers. While copying packets into buffers frees resources, it also introduces an additional copy in to the packet handling process, which increases the load on the memory subsystem. Because packets must be delivered in the order received, additional packets must continue to be copied into buffers even after additional resources are available.

### DESCRIPTION OF DRAWINGS

These and other features and advantages of the invention will become more apparent upon reading the following detailed description and upon reference to the accompanying drawings.

FIG. 1 is a block diagram of a portion of a network which transfers received data packets to the host memory according to one embodiment of the invention.

FIG. 2 is a flowchart illustrating the method of managing the array of packets received by a network controller according to an embodiment of the invention.

### DETAILED DESCRIPTION

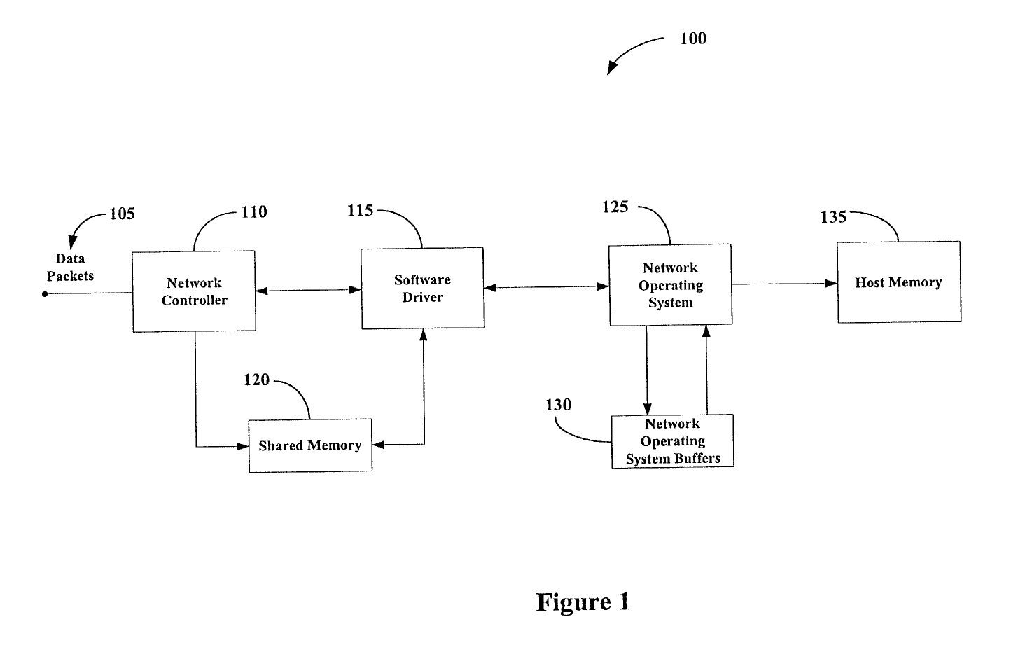

FIG. 1 is a block diagram of a portion of a network 100 which transfers received data packets 105 to a host memory 135. The portion of the network 100 includes a network controller 110, a software driver 115, shared memory 120, a network operating system 125, buffer memory 130, and the host memory 135. The network controller 110 receives packets of data 105 which are to be passed on to the network operating system 125 for processing. The network controller 110 transfers the data packets 105 into the shared memory 120 when the data packets are received. The shared memory 120 is shared between the network controller 110 and the software driver 115. The network controller 110 also provides information, via packet descriptors, regarding the data packets 105 to the software driver 115. The packet descriptors define the specific information about each data packet, e.g. type, length and size. The packet descriptors are communicated to the software driver 115 using shared memory resources. The software driver 115 now has the information necessary to transfer the data packets to the network operating system 125. However, before the shared resources may be reused, the software driver 115 needs to transfer the data packets to the network operating system 125. Because of the nature of computer networks, the data packets 105 should be delivered to the network operating system 125 in the order the data packets were received by the network controller 110.

In certain circumstances, the software driver 115 may collect an array of data packets 105 before transferring the array to the network operating system 125. The array of data packets 105 resides in the shared memory 120 before they are transferred to the network operating system 125. However, the network controller 110 has a limited amount of resources available. If the network controller 110 runs low on resources while processing an array of data packets 105, the network controller 110 must free up some shared memory resources 120 to ensure that newly received data packets 105 can be placed into shared memory 120. In this circumstance, the software driver 115 may instruct the network operating system 125 to copy the array of data packets into operating system buffers 130. Although this frees up resources, it also introduces an additional copy into the packet processing process, thus slowing down the network. The network operating system 125 may eventually copy the data packet array stored in the buffer 130 into the host memory 135.

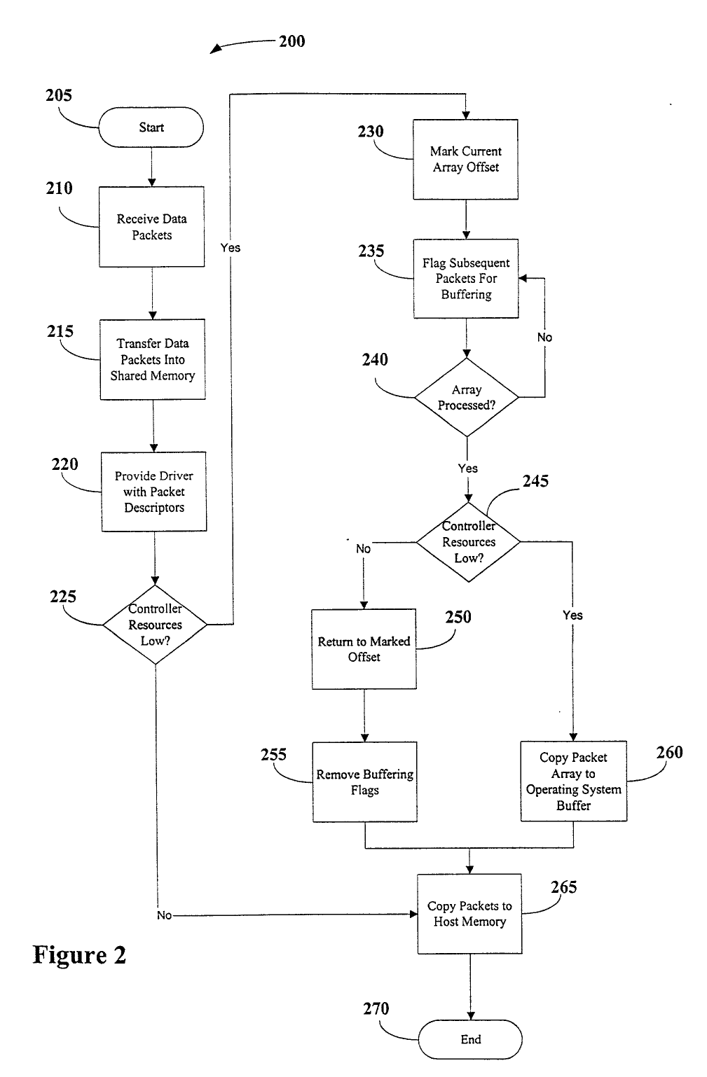

FIG. 2 is a flowchart illustrating the process 200 of managing the array of packets received by a network controller 110. The process 200 begins at a START block 205. Proceeding to block 210, the network controller 110 receives the data packets 105. As stated above, the network controller 110 may receive an array of data packets 105 to be transferred to the host memory 135.

Proceeding to block 215, the network controller 110 transfers the data packets to the shared memory 120. The process 200 then proceeds to block 220. In block 220, the network controller 110 provides the software driver 115 with the packet descriptors. The packet descriptors includes information about the packet data including such items as size, location etc. The software driver 115 may use the information contained in the packet descriptors to coordinate the transfer of the data packets 105.

Proceeding to block 225, the software driver 115 checks the level of resources available to the network controller 110. If the resources run low, the network controller 110 may be in danger of dropping future incoming data packets 105 and thus should plan to buffer current data packets 105 to free up resources. If the resources are not low, the process 200 proceeds along the NO branch to block 265 as will be described below. If the resources are low, the process 200 proceeds along the YES branch to block 230. In block 230, the software driver 115 marks the current array offset of the packet being processed. This allows the software driver 115 to set a beginning packet to transfer to the buffer 130, if necessary.

Proceeding to block 235, the software driver 115 flags all subsequent data packets 105. This flag indicates that the data packets 105 may need to be copied to the buffer 130. The process 200 then proceeds to block 240 to determine if all data packets 105 in the current array are processed. If there are additional data packets 105 in the current array, the process proceeds along the NO branch back to block 235 where the additional data packets 105 are processed and flagged. If the current array has been completely processed, the process 200 proceeds along the YES branch to block 245.

In block 245, the software driver 115 again checks the level of resources available to the network controller 110. Although the software driver 115 has previously determined in block 225 that the resources are low, it is possible that during the processing of the array of data packets, some resources may have become available. Resources may become available if another thread releases resources as the current array is being built. If another thread does release resources, an asynchronous cleanup routine may be used to return the shared resource to the driver. Thus, while the current driver is processing an array, the asynchronous cleanup routine may return resources to the driver. If the resources are determined to still be low, the software driver 115 needs to free up some resources. The process 200 then proceeds along the YES branch to block 260. In block 260, the software driver instructs the operating system to copy the array of data packets 105 to the buffer 130. By transferring the array of data packets 105 to the buffer 130, the software driver 115 makes additional resources available to the network controller.

Returning to block 245, if the software driver 115 determines the current resources are not low, there is no need to transfer the array of packet data to the buffer 130. Thus, the process 200 proceeds along the NO branch to block 250. In block 250, the software driver 115 returns to the marked offset to remove the flag indicating the data packet 105 should be transferred to the buffer 130. The process 200 then proceeds to block 255 where the buffering flags are removed from each of the subsequent data packets 105 in the array.

Proceeding to block 265, the operating system copies the data packets 105 to the host memory 135. If the data packets 105 had been copied to the buffer 130 in block 260, then the data packets 105 are copied from the buffer 130 to the host memory 135. These data packets 105 required two copy steps. However, if the data packets 105 were never copied to the buffer 130, the software driver 115 copies the data packet from the shared memory 120 to the host memory. This procedure only requires one copy step. The additional memory copy used by the data packets 105 in the buffer 130 may be time consuming and require the system processor to actively move packets from the shared memory 120 to the buffers 130. By eliminating the additional copy step, the processor utilization decreases.

Numerous variations and modifications of the invention will become readily apparent to those skilled in the art. Accordingly, the invention may be embodied in other specific forms without departing from its spirit or essential characteristics.

What is claimed is:

1. A method of managing data packets in a network comprising:
determining a low resource condition exists in the shared memory subsystem;
marking a current data packet;
processing an array of data packets, wherein each data packet in the array is flagged for buffering;
checking the resource condition in the shared memory subsystem;
returning to the marked data packet and removing all buffering flags from the data packets if the resources are not low;
copying all flagged data packets to a buffer; and
copying all remaining data packets to a host memory.

2. The method of claim 1, further comprising:
receiving data packets; and
copying the data packets into a shared memory.

3. The method of claim 1, further comprising providing a software driver with descriptors of each data packet.

4. The method of claim 1, further comprising copying the data packets to the host memory if a low resource condition does not exist in the network.

5. The method of claim 1, further comprising determining each data packet in the array has been processed.

6. The method of claim 2, further comprising copying the data packets to the host memory in the order the data packets were received.

7. The method of claim 2, further comprising receiving the data packets with a network controller.

8. A method of transferring data packets comprising:
marking a first data packet;
flagging any subsequent data packet for buffering;
determining network resources are available; and
removing any buffering flags beginning with the marked first data packet.

9. The method of claim 8, further comprising determining initial network resources are limited.

10. The method of claim 8, further comprising copying each data packet to a host memory.

11. The method of claim 10, further comprising:
receiving data packets; and
copying the data packets into a shared memory.

12. The method of claim 11, further comprising copying the data packets to the host memory in the order the data packets were received.

13. The method of claim 8, further comprising processing an array of data packets.

14. An apparatus, including instructions residing on a machine-readable storage medium, for use in a machine system to handle a plurality of instructions, the instructions causing the machine to:
determine a low resource condition exists in the network;
mark a current data packet;
process an array of data packets, wherein each data packet in the array is flagged for buffering;
check the resource condition in the network;
return to the marked data packet and removing all buffering flags from the data packets if the resources are not low;
copy all flagged data packets to a buffer; and
copy all remaining data packets to a host memory.

15. The apparatus of claim 14, further causing the machine to provide a software driver with descriptors of each data packet.

16. The apparatus of claim 14, further causing the machine to copy the data packets to the host memory if a low resource condition does not exist in the network.

17. The apparatus of claim 14, further causing the machine to determine whether each data packet in the array has been processed.

18. The apparatus of claim 15, further causing the machine to copy the data packets to the host memory in the order the data packets were received.
